(19) United States
(12) Patent Application Publication
(10) Pub. No.: US 2010/0318787 A1
(43) Pub. Date: Dec. 16, 2010

(54) Method for Certifying a Public Key by an Uncertified Provider

(75) Inventors: Laurent Maupertuis, Draveil (FR); David Pointcheval, Thiais (FR); Cyrille Giquello, Tours (FR); Bernard Starck, Meudon (FR)

Correspondence Address: HARNESS, DICKEY & PIERCE, P.L.C., P.O. BOX 828, BLOOMFIELD HILLS, MI, 48303, US

(73) Assignee: DIGIMEDIA INTERACTIVITE, Saint Denis (FR)

(21) Appl. No.: 12/224,005

(22) PCT Filed: Dec. 27, 2006
(86) PCT No.: PCT/FR2006/051429

§ 371 Date: Aug. 28, 2009

(30) Foreign Application Priority Data
Feb. 16, 2006 (FR) 0650554

(51) Int. Cl. H04L 9/32

(52) U.S. Cl. 713/156

(57) ABSTRACT

The invention concerns a method for guaranteeing certification of a user's public key by reducing requests to key-certifying appropriate authorities. More particularly, the invention concerns a method for managing a public key of a user capable of being implemented in an asymmetric cryptosystem. According to the invention, a certification, or validation of the correspondence between a public key and a user, is performed by a validating entity, a provider separate from the certifying authority via a validation step. The password is verifiable by the validating entity, but without the latter being aware of it.

### CROSS-REFERENCE TO RELATED APPLICATIONS

This application is a National Phase Entry of International Application No. PCT/FR2006/051429, filed Dec. 27, 2006, claiming priority to French Patent Application No. 06/50554, filed Feb. 16, 2006, both of which are incorporated by reference herein.

### BACKGROUND AND SUMMARY

The present invention relates to the field of data certifying methods.

The certification of data is widely used in the implementation of asymmetric cryptography. In this type of cryptography, each user has two keys, a private key which must be kept secret and a public key which is available to all the other users, both keys being connected mathematically. Such mechanism makes it possible to exchange ciphered and/or signed data.

The known ciphering and signing mechanisms are described hereinunder. In case of a ciphering, in order to send a ciphered message to Bernard, Alice gets Bernard's public key and uses it to cipher the message. Upon the reception thereof, Bernard is able to decipher the message when using his private key. Nobody but him can do this since even though anybody can have access to Bernard's public key, nobody can deduce therefrom the complementary private key thereof.

In the case of a signature, in order to send a signed message, reverting the order of keys is sufficient: the private key becomes the signature key and the public key becomes the checking key. The mechanism then offers the following guarantees: on the one hand, the message thus “signed” has been signed by the private key corresponding to the public key used for the checking; on the other hand, a message could not be modified after the signature or the checking would have failed. Such two characteristics—author's identification, integrity of the signed message—provide an equivalence of the hand-written signature adapted to the electronic context. Such method more particularly gives the quality of non-repudiation to the message thus signed.

However, this sharing mode has a big defect in that nothing guarantees that the key is that of the user it is associated with. As a matter of fact, a hacker may corrupt the public key existing in a public key directory and replace it by his own public key. Let us assume that Oscar, a hacker, wishes to convince Alice that she is receiving messages signed by Bernard, whereas such messages are in fact written by himself. He just has to substitute his own public key for Bernard's in the directory and send his messages to Alice while on the pretext that he is Bernard. In order to check the signature of such messages, Alice will find Bernard's public key (in fact, the hacker's) and as the checking is ok, she will erroneously be convinced of the origin of the messages. Similarly, Bernard could dishonestly repudiate a message he did sent while on the pretext that a hacker has taken his place. Thus, the hacker will be able to sign and/or to cipher all the messages which have been ciphered with the false key existing in the directory, using his false private key and the user could thus repudiate a message on a false pretext.

The distribution of public keys is thus an important problem. As a matter of fact, in order for the ciphering and the signature to work, we must be sure of the identity of the person connected with the public key. For this purpose, a method is generally used for certifying public keys.

A certificate makes it possible to associate a public key with an authority like a person or a machine in order to guarantee the validity thereof. The certificate is some sort of an identification card of the public key, issued by an organisation called the Certifying authority (also indicated by CA). A certificate by an authority associated to a first element A and to a second element B thus includes at least one signature of the type sk_{authority} (A, B), sk_{authority} being the private key of the authority issuing the certificate certifying that the element A is indeed associated with the element B. The certifying authority is in charge of issuing the certificates, assigning them a date of validity (equivalent to the “best before” date on foodstuffs), as well as repudiating certificates before this date, in case the key (or the owner) is compromised.

A certificate therefore includes a first part corresponding to information relating to the owner of the public key, as well as to the authority issuing the certificate, and a second part corresponding to the signature of the certifying authority with for example a type format:

### Information:

name of the certifying authority: Mr. Dupont, bailiff.

name of the owner of the public key: Mr. Durand

public key: 1a:5b:3c:a5:32:4c:d6

### Signature:

d9:6d:4a:2g:1b:3c:F2

The combination of hardware, software and procedure elements which make it possible to perform all the operations involved in the making of the cryptographic signature (and ciphering) is called public key infrastructure (ICP or PKI), i.e.:

Generation of cryptographic keys: the pairs of cryptographic keys must be produced in a very safe way;

Users' logging: the certifying authority must check the identity of each user for example, through the presentation in person of identification cards;

Certification of public keys: Once the identity of the user is confirmed, the certifying authority must issue the certificate and sign it with its private key;

Generation of the users' private keys: A reliable method must make it possible to generate the user's keys.

Directory: The certificate must be placed within a directory so that other users can have access to it and can check the signatures;

Cancellation of compromised or expired certificates: A service must make it possible to cancel the certificates when they are expired or when a private key has been compromised. Thus, when a certificate of a public key is cancelled, it can no longer be used to check the messages signed using the associated private key;

Records: All the certificates making it possible to check, the list of repudiation, etc., must be kept so that the verification can be carried out subsequently;

Time stamping: The certificates and the signatures must be time stamped in a reliable way.

An organization wishing to use a PKI may transfer the whole of such functions to a supplier or, on the contrary, may carry them out as a whole or in part. Such list makes it possible, however, to see the complexity of the infrastructure required for the deployment of the cryptographic signature. In a way known per se, the structure of the certificate is standardized according to standard X.509.

All the information (information+applicant's public key) is signed by the certifying authority. This means that a hashing function makes a print of such information and then this condensate signed using the private key of the certifying authority; the public key of the certifying authority is previously largely emitted in order to make it possible for the users to check the signature with the certifying authority's public key. When the user wishes to communicate with another person, he just has to get the destiny's certificate. Such certificate mentions the name of the addressee, as well as his or her public key and is signed by the certifying authority. Thus it is possible to check the validity of the message by applying on the one hand a hashing function to the information contained in the certificate and on the other hand by checking the signature of the authority with the latter's public key, with respect to the hashed value.

Some authorities also called certifying authorities are authorized to make a certification of public keys. This is for example made by a bailiff who certifies the correspondence between a public key and a user by an electronic signature belonging only to him. However, this step of certification is complex because it assumes that the bailiff must check the user's identity before signing his public key, for example through the checking of its identity. Such authority is thus very much in demand which can be incompatible with its high responsibility.

A first aim of the present invention is thus to be able to guarantee the certification of a user's public key, while reducing the demand from the key certifying authorities. A known solution to such disadvantage consists in letting such certifying authority generate both the user's public key and private key, in certifying his public key and in handing over to him all the keys as well as the certificate. Such solution, however, has the disadvantage that the authority knows the user's secret key and will be able to sign on his/her behalf and in his/her name or to decipher his/her communications. In such conditions, the message or the transaction looses its quality of non-repudiation.

Another aim of the present invention is thus to be able to guarantee the certification of a user's public key by reducing the demand from the key certifying competent authorities while avoiding the disadvantages of generating the user's public key and secret key by a competent authority. In addition, it is of common practice that technical suppliers different from the certifying authorities participate in the certification process (Electronic Certification Supplier ECS). In order to maintain the qualification of said certificate, it is necessary that the supplier is recognized by the certifying authority in order to have the same quality of reliability as said certifying authority. In the other cases, the reliability which is granted to a non recognized supplier is lower than that granted to the certifying authority. It can be limited or even null. Such a supplier is thus able, in the known systems, to generate certificates and thus to sign with its private signature a public key and a user identifier and then to use this certificate without the user knowing it.

The publication “Digital image recording for court-related purposes” by Rieger et al., in Security Technology, 1999, discloses, for example, a user public keys managing infrastructure comprising a certifying entity and a validating entity. Such validating entity is an electronic certification supplier and generates public key certificates for the users' public keys. This can involve problems for example as regards the digital signature of contracts and transactions.

A disadvantage of the presence of a non recognized third party who can deliver certificates thus resides in the possibility for this third party to use such certificates in a fraudulent way. Under such conditions, the certification chain does not sufficiently guarantees the integrity and the non repudiation of the signed messages. In this scheme, there is no true equivalence between the digital signature and the hand-written signature.

Another aim of the present invention thus consists in allowing the generation, by a supplying third party, of a certificate guaranteeing the correspondence between a public key and a user, without this certificate being usable by the third party without the latter being exposed. These suppliers are also called “validating entities”. In addition, it is important that the certificate issued by the supplying third party is valid, i.e. that it really shows, more particularly from a legal point of view, the correspondence between a public key and a user. For this purpose, it is necessary for the certificate to be issued to the user only as a function of data depending not only on him, since the third party is not recognized, but depending on the certifying authorities.

Another aim of the present invention thus consists in having the issuance of a certificate by a non recognized third party supplier depend on data certified by the certifying authority, known to a user, but not to said third party. At least one of these aims is reached according to the present invention by a method for the management of the public key of a user, said user having a unique identification, characterized in that it includes:
a step of certification consisting in:

generating, at the level of a certifying entity, at least one password;

transmitting from said certifying authority to said user, at least one secret data associated with said at least one password;

deducing, at the level of said user, said at least one password from said at least one secret data;

generating, at the level of said certifying entity, from said at least one password, at least one derived password, said at least one derived password being derived in a one-way direction from at least one password through a one-way function;
a step of exchange consisting in:

transmitting, from said certifying entity to a validating entity, at least one certificate from said certifying entity associated with said unique identifier of said user and with at least one derived password;
a step of request for validation consisting in:

generating, at the level of said user, a secret key associated with the public key;

transmitting, from said user to said validating authority, said public key and said unique identification;

transmitting, from said user to said validating entity, a test value;
a step of validation consisting in:

In case of a correspondence, at the level of said validating entity, between the value derived from said test value through said one-way function and a validated derived password among said at least one derived password, transmitting to said user a validation certificate from the validating entity associated with at least said user identifier and with said public key.

Thus, by certifying said password to the user, the certifying authority guarantees the correspondence between such password and a determined user. In the method according to the invention, this is the only action by the certifying authority and more particularly the latter no longer has to certify the public keys generated by the user, more particularly in the case where several sets of public keys are generated. As a matter of fact, according to the invention, this certification, or validation, of the correspondence between the public key and a user is performed by the validating entity, a supplier different from the certifying authority through the step of validation. Said user password can thus be checked by the validating entity without the latter knowing it.

Thus, in the method according to the invention, the validating entity guarantees a true certification of the user's public key, without being able however to generate fraudulent certificates except when using again the password it has just learnt, possibly prior to having completed the process of certification with the user, in order to generate a certificate in the name of the user himself. Therefore, it is advantageous that the certificate emitted by the user incorporates information generated and certified by the certifying authority and known to him only, so that the validating authority has no interest in interrupting the process of certification. More particularly, it is advantageous that the certificate emitted by the user incorporates information which is not known by the validating authority which issued a certificate guarantying the correspondence between the user's public key and the user.

For this purpose, in the above-mentioned method, said step of certification further comprises a step consisting in:

deducing at the level of said user, at least one word of acknowledgement for said at least one secret data, each of said at least one password being derived in a one-way direction from each of said at least one word of acknowledgement;

and said method also comprises:

a step of certified transaction to a transaction entity comprising steps consisting in:

transmitting, from said user to said transaction entity, a transaction certificate comprising at least said validation certificate and one of said at least one word of acknowledgement.

Thus, the certificate transmitted to the transaction entity includes a word of acknowledgement from which is derived, in a one-way direction, the password which has been transmitted by the user to the validating entity. The validating entity thus does not know, and has no way to know, the value of this word of acknowledgement before the effective utilization of the certificate. However, the password is derived from this word of acknowledgement, as well as the derived password certified by the authority. Thus, this word of acknowledgement has been certified by the validating entity, when the latter emitted the certificate representative of the correspondence between the password and said user.

Thus, the validating entity can generate a valid transaction certificate by taking advantage of the information received at step of validation, since such transaction certificate depends on a value which is unknown to it, i.e. a word of acknowledgement. Besides, in the above-mentioned method, when the user has transmitted his/her transaction certificate, he/she unveils the value of the word of acknowledgement, more particularly to the validating entity. It should thus be advantageous to make the distinction between the new utilization of the word of acknowledgement by the user to be handed over a second certificate (or renew a request which would have been interrupted), and the utilization of such word of acknowledgement by the validating entity to generate a fraudulent certificate.

Thus it is the validating entity's interest to highlight such a distinction, not to be wrongly charged with fraud. For this purpose, in the above-mentioned method, each of said at least one word of acknowledgement is associated with a unique index, and each of said at least one password being derived in a one-way direction from each of said at least one word of acknowledgement is associated with the index of said word of acknowledgement it is derived from;
said step of request for validation includes, further to the transmission from said user to said validating entity, of said public key, a step consisting in:

storing, in storage means, at the level of said validating entity, a counting digital identifier;

transmitting, from said validating entity, to said user said counting digital identifier;
said validation step consisting in:

In case of a correspondence, at the level of said validating entity, between the derivative of the test value by said one-way function and a validated derived password, the index of which corresponds to said counting digital identifier, among said at least one derived password, transmitting to said user a validation certificate from the validating entity associated with at least said user's identifier, to said public key, to said validated derived password, and to said counting digital identifier;

Modifying said counting digital identifier in said storing means of said validating entity;
said step of certified transaction to a transaction entity comprising steps consisting in:

transmitting, from said user to said transaction entity, a transaction certificate comprising at least said validation certificate, said word of acknowledgement, the index of which is that of said validated derived password, and the index of said word of acknowledgement.

Thus, if the validating entity does modify its counting digital identifiers or counter, each time it validated a correspondence between the public key and a user, the certificates emitted by a validating entity for the same user all include a different counter. Thus, if the validating entity has correctly implemented the above method, if two certificates have been transmitted with the same index, this means that the supplier is at fault. As a matter of fact, if the user had wanted to get a second certificate or renew a request, the index corresponding to the counting digital identifier in the certificate emitted by the validating entity would have been different. In order to facilitate the implementation of the method, it can be arranged that the indexes of each one of said words of acknowledgement are all distinct and ordered. In this case, the modification of said counting digital identifier in said storing means of said validating entity is an increment.

Besides, according to a particularly embodiment of the invention, said at least one secret data corresponds to a secret, each of said at least one password being derived in a one-way direction from said secret. According to such embodiment, a unique secret word is transmitted to the user and the calculations of the password are made by the user's calculator. Thus, the secret transmitted to the user is short, for example of 12 characters according to safety requirements.

Still in this embodiment, the calculations of the word of acknowledgement can be made at the level of the user's station. In this case, said step of certification includes steps consisting in:

transmitting, from said certifying authority to said user, said secret;

calculating, at the level of said user, at least one word of acknowledgement, each one of said at least one word of acknowledgement being derived in a one-way direction from said secret;

calculating, at the level of said user, said at least one password, each of said at least one password being derived in the one-way direction from each of said at least one word of acknowledgement.

It is also possible to combine the utilization of a counting digital identifier and the calculation, at the level of the user's station. In this case, said step of certification includes the steps consisting in:

transmitting from said certifying authority to said user, said secret;

calculating, at the level of said user, at least one word of acknowledgement, each of said at least one word of acknowledgement being associated with a unique index derived in a one-way direction from said secret;

calculating, at the level of said user, said at least one password, each of said at least password being derived in a one-way direction from each of said at least one word of acknowledgement and being associated with said index of said word of acknowledgement it is derived from;
said step of application for a validation includes, further to the transmission from said user to said validating entity, of said public key, a step consisting in:

storing, in storage means, a counting digital identifier at the level of said validating entity;

transmitting said counting digital identifier from said validating entity to said user;
said step of validation consisting in:

In case of a correspondence, at the level of said validating entity, between the value derived from said test value by said one-way function and a validated derived password, the index of which corresponds to said counting digital identifier among said at least one derived password, transmitting to said user a certificate of validation from the validating entity associated with at least said identifier of said user, said public key, said validated derived password and said counting digital identifier;

Modifying said counting digital identifier and said storage means of said validating entity;
said step of certified transaction to a transaction entity, comprising steps consisting in:

transmitting, from said user to said transaction entity, a transaction certificate comprising at least said validation certificate, said word of acknowledgement, the index of which is that of said validated derived password, and the index of said word of acknowledgement.

In addition, the recognition of the certifying authority may also be questioned. In this case, it is advantageous that a secret shared by the user and the validating entity but unknown to the certifying entity exists in the method. For this purpose, in the method as described hereabove, said step of request for validation comprises a first sub-step of transmission, from said validating entity to said user of a second password; and a second sub-step of transmission from said user to said validating authority of a second test value, said step of validation being carried out only in the case of a correspondence between said second password and said second test value. Thus, it is guaranteed that the validation certificate will not be issued but to the user knowing the second password and thus not to the certifying authority should it want to defraud.

### BRIEF DESCRIPTION OF DRAWINGS

The invention will be best understood while reading the detailed description mentioned hereunder and the appended Figures where:

FIG. 1 shows a general diagram of the exchanges between the various entities acting within the scope of the present invention;

FIG. 2 shows a detailed diagram of the exchanges between a user and a certifying entity according to an embodiment of the invention; and

FIG. 3 shows a detailed diagram of the exchanges between a user and a validating entity according to an embodiment of the present invention.

### DETAILED DESCRIPTION

First, notations are defined for the purpose of the present application. A signature algorithm is Ssk(m) returning a signature a on the message m using a private key sk is firstly defined. A checking algorithm Vvk(m;σ) is also defined which checks the validity of the signature a with respect to the message m and to the public key vk.

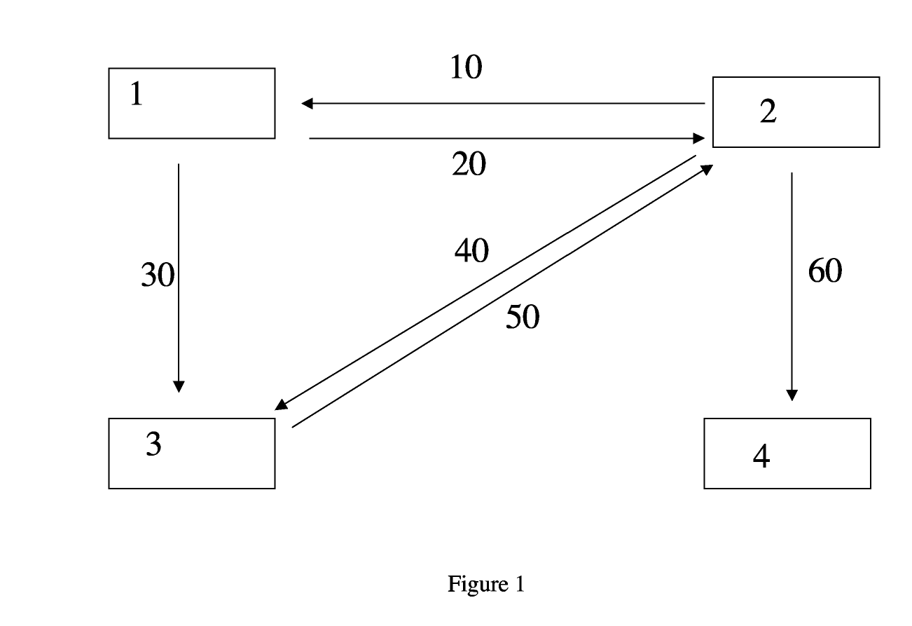

As illustrated in FIG. 1, the present invention is based on the exchanges between various entities, for a utilisation in an asymmetric cryptosystem. It concerns a user 2 who wants to obtain a certificate on a public key he has generated himself, a certifying entity 1 which is, a priori, the only trustworthy person, capable of certifying data. In a conventional way, such

certifying entity 1 is for example a bailiff. It also concerns a validating entity 3, also called subsequently a supplier, which owns a certification key, but which is not considered as reliable for issuing certificates. Such validating entity 3 carries out most of the calculations, storages and interactions with the user. It also concerns a transaction entity 4, with which the user wishes to make a certified transaction.

Then, the private key from the certifying entity is noted skₐ, and its public key vkₐ. The private key from the validating entity is indicated skₚ and its public key vkₚ. According to the invention, each user 2 has a public identifier which is unique: login. The certifying authority 1 generates 20 a secret sec which is transmitted to the user 2 when the user shows 10 its login identifier.

The certifying authority also transmits 30 to the supplier means for checking the validity of the user's secret sec. Such checking means will be described in greater detail hereunder. In order to have a public key certified, the user transmits 40 such public key to the validating entity. In answer and if the validating entity thinks that the public key is properly associated with the user 2, it transmits 50 a certificate associating such public key with such user. The user can then carry out a transaction to a transaction entity while using data of the certificate he has received from the checking entity, during a step 60.

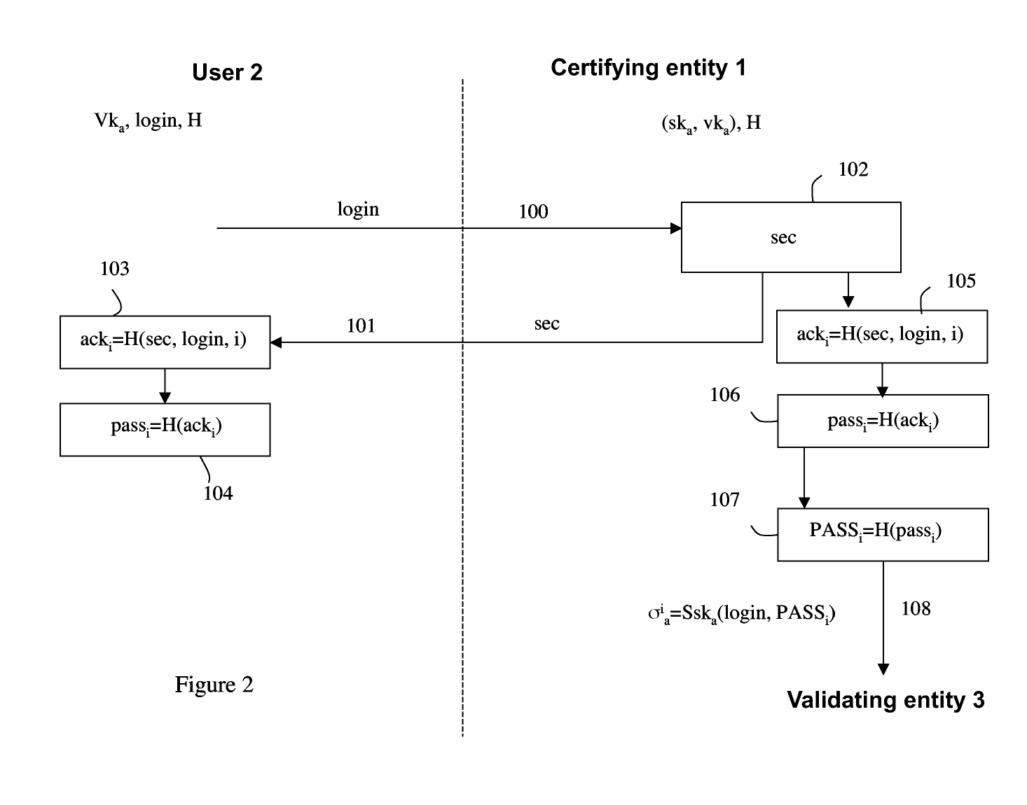

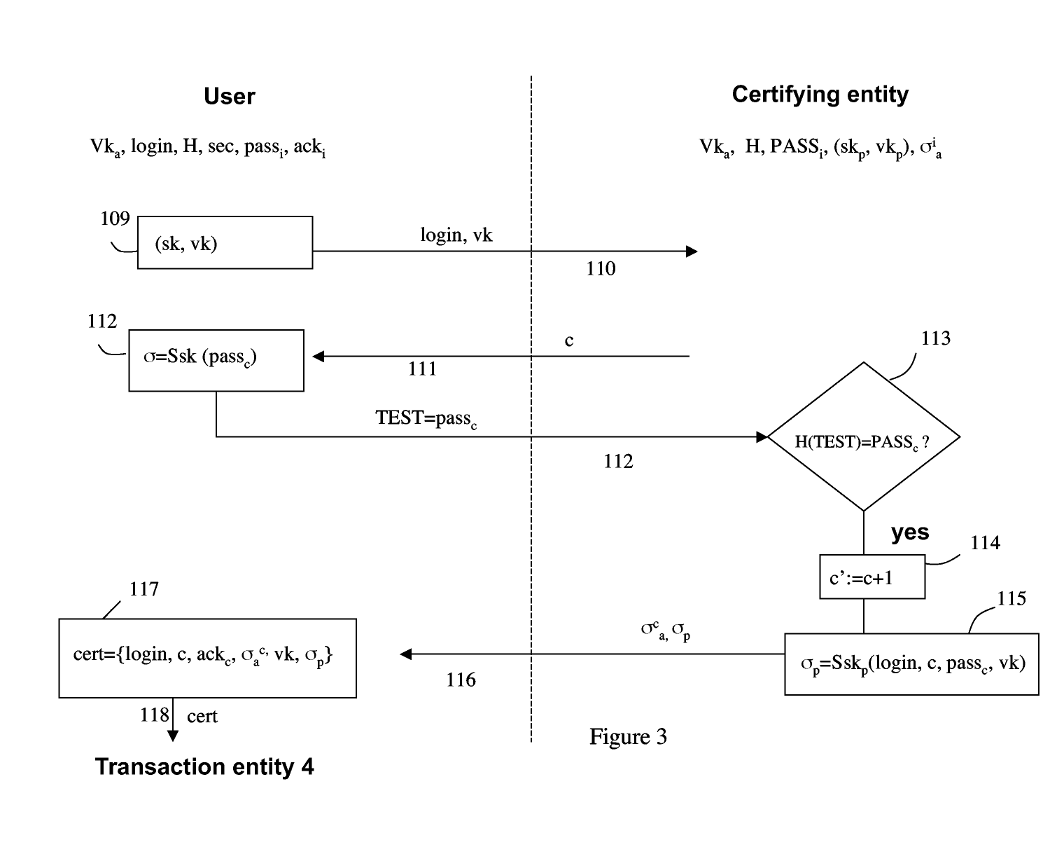

Now the exchanges between the various entities described hereabove while referring to FIGS. 2 and 3 are being described. Derived values from the secret sec are first defined. In the field of cryptography, such derivative corresponds to the application of a one-way function which means that if H is a one-way function and if only the result H(x) is available, it is very difficult or even impossible to find x within a reasonable time. An example of such a one-way function is the hashing function SHA-1 which is known to the person skilled in the art.

Several derivatives of the secret sec are thus defined, first in the form of words of acknowledgement ackᵢ, passwords pass, and checking words PASSi with, for example:

### When I=1, . . . , k,

ackᵢ=H(sec, login, i)

passᵢ=H(ackᵢ)

PASSᵢ=H(passᵢ)

According to this definition, it should be noted that ackᵢ is different from ackⱼ if i is different from j and that, consequently passᵢ (respectively PASSᵢ) is different from passⱼ (respectively PASSⱼ) if i different from j.

FIG. 2 shows detailed exchanges between the user 2 and the certifying entity 1 such as referenced in 10 and 20 in FIG. 1. The user 2 initially knows his identifier login, the public key of the certifying entity vkₐ and the one-way function H used to make the derivatives. The certifying authority 1 initially knows its public key vkₐ, its private key skₐ and the one-way function H used for making the derivatives.

The user 2 transmits 100 his identifier login to the certifying authority. By return, the latter generates a secret sec during a step 102. Then, it transmits 101 such secret to the user 2. According to one embodiment of the invention, the user is able to calculate the words of acknowledgement ackᵢ and the passwords pass, such as previously defined at steps 103 and 104. The certifying entity also calculates such variables at steps 105 and 106. It also calculates checking words PASS, during a step 107, it certifies them and transmits them 108 to the validating entity.

Thus, when the checking words are certified, the validity of the other words can also be checked by an application of a one-way function. The validity of the passwords pass, is thus checked by testing if H(passᵢ)=PASSᵢ and the validity of the words of acknowledgement is checked by testing if H²(ackᵢ)=H(passᵢ)=Passᵢ. The parameter k, such as previously defined, is here a security parameter which refers to the maximum number of fruitless connections attempts, caused by hardware or network trouble or of dishonest attempts by a user 2. Depending on the implementation context of the present invention, the parameter k may, for example, have values between a few units and several dozens.

Thus, further to the checking, the user at least has the following variables: sec, passᵢ, ackᵢ. The validating entity at least has the checking words PASSᵢ. More particularly, it doesn't have the words sec, passᵢ, ackᵢ which are the user's own.

Now, an exemplary method for certifying is now described between the user 2 and the checking entity 3 while referring to FIG. 3. The user 2 generates 109, for example using an algorithm G located in its calculator, a couple of signature keys (sk, vk) and wishes a certificate on vk. It transmits vk to the validating entity together with his login during a step 110.

As for the validating entity, it manages the counting digital identifier or counter c for the connection attempts by the user. Such counter c indicates how many times the user 2 identified by his login attempted to connect to the certification service through the validating entity. The certifying entity transmits 111 the current value of the counter c to the user upon receiving his identifier login and the user's public key vk. The user must then prove that he knows the signature key sk associated with the key vk to be certified, as well as the derivative from the secret sec by producing 112 a signature on the password having an index c equal to the current value received from the counter σ=Sₛₖ(pass_{c}).

Now, the method of certifying making it possible to obtain a certificate from the validating entity will be described. However, it should be noted that if the values supplied by the user generally indicated by TEST do not correspond to the correct implementation of the method, the certification will be refused. Then, it is assumed that the value transmitted to the validating entity at step 112 does correspond to a correct TEST value.

The supplier then checks the user's signature thanks to the public key he received previously and thus tests Vvk(pass_{c}; a). He also checks 113 the password pass_{c} by testing PASS_{c}=H(pass_{c}). He also increments the counter c at step 114.

Once the data have been verified, the supplier is thus sure that the password pass_{c} is associated with the user's identifier login and that the public key is associated with the user's identifier login. The supplier then signs 115 in the quadruple (login, c, pass_{c}, vk) using his private key skₚ and transmits 116 such signature σₚ=Sₛₖₚ(login, c, pass_{c}, vk) to the user.

It also transmits to the user, at step 116, the certificate received from the certifying entity σₐ^{c}; on the checking word PASS_{c}. The checking word transmitted is thus the checking word, the index of which corresponds to the counter for the attempted connections by the user 2 such as transmitted to the user at step 111.

The user then checks the validity of σₚ using Vvkₚ (σₚ; (login, c, pass_{c}, vk)), vkₚ being the public key of the supplier and generates 117 a certificate in the form of a n-uple cert=(login, c, ack_{c}, σₐ^{c}, vk, σₚ). According to the invention, it should be noted that such certificate can be checked by everyone thanks to the following checking functions:

Vvkₚ(login, c, H(ack_{c}), vk; σₚ) to check login, c, ack_{c}, and vk;
Vvkₐ(login, PASS_{c}; σₐ^{c}) to check login and PASS_{c};
H² (ack_{c}) to check ackc using PASS_{c}.
This certificate can thus be checked by everyone and is transmitted to the transaction entity 4 at step 118. Such certificate then guarantees that the public key vk is associated with the user 2 identified by his login.

The method according to the invention makes it possible to supply a high level of security. As a matter of fact, the user only can get a certificate cert in his name since such a certificate incorporates a value unknown to the supplier (ack_{c}) before the user uses his certificate with the index c. In any other case, the supplier could take advantage of the information learnt during the certification.

In addition, the value ack_{c} is required to validate the certificate. Such information is disclosed only when the user has received a valid signature σₚ during the utilisation of the certificate cert. A second signature σₚ having the same counter value then accuses the supplier. It should be noted that therefor the user must keep a copy of his certificate. In addition, if the user tries to have the supplier charged or if a network trouble blocks the communications, the supplier increments the counter and thus cannot be accused so long as two signature σₚ will never be emitted with the same counter.

Now the size of the variables used within the scope of the present invention in order to guarantee a sufficient security level will be disclosed. Selecting a 60-bit secret sec, and a one-way hashing function of the SHA-1 type, an exhaustive search to find the secret sec from the values of the checking words PASSⱼ requires an average of 2⁶⁰ estimations of SHA-1. The time required to make such estimations gives enough security within the scope of the present invention. Such a 60-bit secret sec can thus be encoded using 12 alphanumerical characters. Thus, according to the invention, this short 12-character secret can be transmitted in a confidential way to the user and kept safely by him.

It should be noted that, during the management of the objects to be signed, stored and/or transmitted, prints of such objects are sometimes sufficient. In a way known per se, such prints are compressed versions of the total object so that it is impossible to find two objects having the same print.

In addition, like any other key management infrastructure, the certification may be associated with the revocation. As a matter of fact, in case the secret key (or the secret sec) is lost or corrupted by the user, it is necessary not to consider the associated public keys as belonging to their legal owner anymore. Therefore, it is sufficient to keep a list of revocation, mentioning the certificates or the public keys which must no longer be considered as authentic. However, the revocation requires a strong authentication from the person making the application, and the latter can no longer use his/her secret key since he/she is making a request for revocation because he/she lost it. Usually questions are prepared concerning the user (his/her mother's maiden name, his/her pet's name, etc).

Once again, the supplier cannot be trusted since he could wish to revoke a user without the latter knowing it. The user will thus be asked to sign his/her answers, previously ciphered with the certifying authority's public key to make them inaccessible to the supplier. Upon an application for revocation, the user contacts the supplier and sends one or several answers to the questions. The supplier transmits the request to the certifying authority which gives him or not the authorization to proceed with the revocation by adding the certificate or the public key to a list of revocation.

Now, alternative solutions for the present invention such as described in details hereunder are being described in a particular embodiment. In the embodiment such as described hereabove, the certifying entity transmits a unique secret sec to the user and the latter calculates the passwords pass, and words of acknowledgement ackᵢ. According to an alternative, it is also possible that the certifying entity directly transmits to the user the passwords ackᵢ and/or the password passᵢ. In this case, the steps 103 and 104 of calculations of values ackᵢ and passᵢ may be replaced with steps of transmission of such values from the certifying entity to the user. Anyway, it is important, according to the present invention, that the user has data which may be the secret sec, the passwords pass, or the words of acknowledgement ackᵢ he/she shares with the certifying authority only, and which is not known to the supplier but which can be checked by him.

In another alternative solution, if the certifying entity is not totally reliable, it is possible that the user and the supplier exchange a second password indicated pw which is not known to the certifying entity. Such password is then transmitted from the user to the supplier when the user wishes to have his public key certified. If the second password is not acknowledged by the validating entity, no checking is carried out and the method is stopped. This gives the advantage of preventing the certifying entity from acting on behalf of the user.

1. A method for managing a user's public key, said user having a unique identifier, the method comprising:
(a) a step of certification comprising:
generating at the level of a certifying entity at least a password;
transmitting from said certifying authority to said user at least one secret data associated with at least one password;
deducing at the level of said user, said at least one password of said at least one secret data;
generating at the level of said certifying entity, from said at least one password, at least one derived password, said at least one derived password being derived in a one-way direction from said at least one password by a one-way function;
(b) a step of exchanging comprising:
transmitting from said certifying entity to a validating entity, at least a certificate of said certifying entity associated with said user's unique identifier and with said at least one derived password;
(c) a step of requesting a validation comprising:
generating, at the level of said user, a secret key associated with a public key;
transmitting from said user to said validating entity, said public key and said unique identifier;
transmitting, from said user to said validating entity a test value; and
(d) a step of validation comprising:
in case of correspondence, at the level of said validating entity, between a derivative of said test value by said one-way function and a validated derived password among said at least one derived password, transmitting to said user a certificate of validation from the validating entity associated with at least said user's identification and with said public key.

2. A method according to claim 1, wherein said step of certifying further comprises:
deducing, at the level of said user, at least a word of acknowledgement of said at least one secret data, each of said at least one password being derived in a one-way direction, from each of said at least one word of acknowledgement;
and said method also comprises:
a step of certified transaction to a transaction entity comprising:
transmitting from said user to the said transaction entity, a certificate of transaction further comprising at least said validation certificate and one of the at least one word of acknowledgement.

3. A method according to claim 2, wherein each of said at least one word of acknowledgement is associated with a unique index, each of said at least one password being derived in a one-way direction from each of said at least one word of acknowledgement and being associated with the index of said word of acknowledgement which it is derived from;
(a) said step of request of validation comprises, so that, further to the transmission from said user to said validating entity of said public key, further comprising:
storing in the storage means at the level of said validating entity a counting digital identifier;
transmitting from said validating entity to said user, said counting digital identifier;
(b) said validation step comprising:
in case of correspondence, at the level of said validating entity, between the derivative of said test value by said one-way function and a validated derived password, the index of which corresponds to said counting digital identifier among said at least one derived password, transmitting to said user a certificate of validation from the validating entity associated with at least said identifier of said user, to said public key, to said validated derived password and to said counting digital identifier;
modifying said counting numerical identifier in said storage means of said validating entity;
(c) said certified transaction step to a transaction entity comprising:
transmitting, from said user to said transaction entity, a transaction certificate comprising at least the said validation certificate, the said word of acknowledgement, the index of which a is that of said validated derived password, and the index of said word of acknowledgement.

4. A method according to claim 1, wherein said at least one secret data corresponds to a secret, each of said at least one password being derived in a one-way direction from said secret.

5. A method according to claim 4, wherein said certifying step further comprises:
transmitting, from said certifying authority to said user, said secret;
calculating, at the level of said user, at least one word of acknowledgement each said at least one word of acknowledgement being derived in a one-way direction from said secret; and
calculating, at the level of said user, said at least one password, each of said at least one password being derived in a one-way direction from each of said at least one word of acknowledgement.

6. A method according to claim 4, wherein:
(a) said step of certification further comprises:
transmitting from said certifying authority to said user, said secret;
calculating, at the level of said user, at least one word of acknowledgement, each of said at least one word of acknowledgement being associated with a unique index derived in a one-way direction from said secret;
calculating, at the level of said user, said at least one password, each of said at least one password being derived in a one-way direction from each of said at least one word of acknowledgement and being associated with said index from said word of acknowledgement it is derived from;
(b) said step of requesting a validation comprises, further to the transmission from said user to said validating entity of said public key, further comprising:
storing in storage means, at the level of said validating entity, a counting digital identifier;
transmitting from said validating entity to said user, said counting digital identifier;
(c) said step of validation further comprising:
in case of correspondence, at the level of said validating entity, between the derivative of said test value by said one-way function and a validated derived password, the index of which corresponds to said counting digital identifier among said at least one derived password, transmitting to said user a certificate of validation from said validating entity associated with at least said user's identifier (login), to said public key, to said validated derived password and to said counting digital identifier;
modifying said counting digital identifier in said storage means of said validating entity; and
(d) said step of certified transaction to a transaction entity, further comprising:
transmitting, from said user to said transaction entity, a transaction certificate comprising at least said validation certificate, said word of acknowledgement, the index of which is that of said validated derived password and the index of said word of acknowledgement.

7. A method according to claim 1, wherein said step of requesting a validation further comprising a first sub-step of transmission from said validating entity to said user, of a second password; a second sub-step of transmission from said user to said validating entity of a second test value, said step of validation being carried out only in the case of correspondence between said second password and said second test value.
